(19) United States
(12) Patent Application Publication
(10) Pub. No.: US 2023/0224076 A1
(43) Pub. Date: Jul. 13, 2023

(54) PROCESSOR AND SYSTEM

(71) Applicant: Fujitsu Limited, Kawasaki-shi (JP)

(72) Inventor: Yosuke Nakamura, kawasaki (JP)

(73) Assignee: Fujitsu Limited, Kawasaki-shi (JP)

(21) Appl. No.: 17/961,083

(22) Filed: Oct. 6, 2022

(30) Foreign Application Priority Data
Jan. 7, 2022 (JP) 2022-001668

(51) Int. Cl. H04L 1/00

(52) U.S. Cl. CPC H04L 1/0057; H04L 1/0041

(57) ABSTRACT

A processor includes a plurality of data transmitters which transmit data to a plurality of first signal lines, respectively. The processor also includes a plurality of transmission data generators which respectively generate a plurality of first transmission data by respectively adding error correction codes to a plurality of data and a first data distributor that distributes and transfers a plurality of sub-data pieces included in each of the plurality of first transmission data to the plurality of data transmitters. Whereby, the data is kept correctable, even if one of the first signal lines has a permanent fault.

### CROSS-REFERENCE TO RELATED APPLICATION

This application is based upon and claims the benefit of priority of the prior Japanese Patent Application No. 2022-1668, filed on Jan. 7, 2022, the entire contents of which are incorporated herein by reference.

### FIELD

Embodiments discussed herein are related to a processor and a system.

### BACKGROUND

In order to detect and correct an error occurring in data transmitted from a transmission apparatus to a reception apparatus, there is a case where the transmission apparatus is equipped with an error correction coding circuit to code transmission data, while a reception apparatus is equipped with an error correction decoding circuit to decode received data. For example, the error correction coding circuit generates transmission data by rearranging data, coding the rearranged data in predetermined units, rearranging the coded data in a procedure reverse to the rearrangement before the coding, and multiplexing the rearranged data. The error correction decoding circuit generates received data by rearranging the received data, decoding the rearranged data in predetermined units, and rearranging the decoded data in the procedure reverse to the rearrangement before the decoding.

International Publication Pamphlet No. WO 2006/027838 is disclosed as related art.

### SUMMARY

According to an aspect of the embodiments, a processor includes a plurality of data transmitters which transmit data to a plurality of first signal lines, respectively; a plurality of transmission data generators which respectively generate a plurality of first transmission data by respectively adding error correction codes to a plurality of data; and a first data distributor that distributes and transfers a plurality of sub-data pieces included in each of the plurality of first transmission data to the plurality of data transmitters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a data transmission block in a processor in one embodiment;

FIG. 2 is a block diagram illustrating an example of a data reception block mounted on the processor illustrated in FIG. 1;

FIG. 3 is a block diagram illustrating an example of a system including a processor in another embodiment;

FIG. 4 is a block diagram illustrating an example of a data control unit illustrated in FIG. 3;

FIG. 5 is a circuit diagram illustrating an example of data selectors in a transmission data selection unit illustrated in FIG. 4;

FIG. 6 is a circuit diagram illustrating an example of data selectors in a received data selection unit illustrated in FIG. 4;

FIG. 7 is a timing chart illustrating an example of an operation of transmitting 16 bits of data pieces by a data transmitter in FIG. 3;

FIGS. 8A and 8B are explanatory diagrams illustrating examples of specifications about data selection by the transmission data selection unit and the received data selection unit in FIG. 4;

FIGS. 9A and 9B are, as a whole, an explanatory diagram illustrating an example of a data transmission-reception operation (1) between the data control units in FIG. 3;

FIG. 10 is an explanatory diagram illustrating an example of occurrence of bit errors in the operation illustrated in FIG. 9;

FIGS. 11A and 11B are, as a whole, an explanatory diagram illustrating an example of a data transmission-reception operation (2) between the data control units in FIG. 3;

FIGS. 12A and 12B are, as a whole, an explanatory diagram illustrating an example of a data transmission-reception operation (3) between the data control units in FIG. 3;

FIGS. 13A and 13B are, as a whole, an explanatory diagram illustrating an example of a data transmission-reception operation (4) between the data control units in FIG. 3; and

FIG. 14 is an explanatory diagram illustrating an example of a transmission-reception operation by another processor that does not include a transmission data selection unit and a received data selection unit in FIG. 4.

### DESCRIPTION OF EMBODIMENTS

Hereinafter, embodiments will be described with reference to the drawings.

For example, in a case where a permanent fault exists in any of multiple signal lines, parallel data transmission from a transmission apparatus to a reception apparatus via the multiple signal lines results in errors in the data transmitted via the defective signal line having the permanent fault. A reception apparatus is assumed to be capable of correcting an error in one bit and detecting errors in two bits. For example, in a case where multiple bits of data coded by the transmission apparatus are transmitted to the reception apparatus via the defective signal line, the reception apparatus has no way to correct the errors.

According to one aspect, an object of the present disclosure is to reduce occurrence of uncorrectable errors by stopping data having an error correction code added from being transmitted via a defective signal line in a concentrated manner.

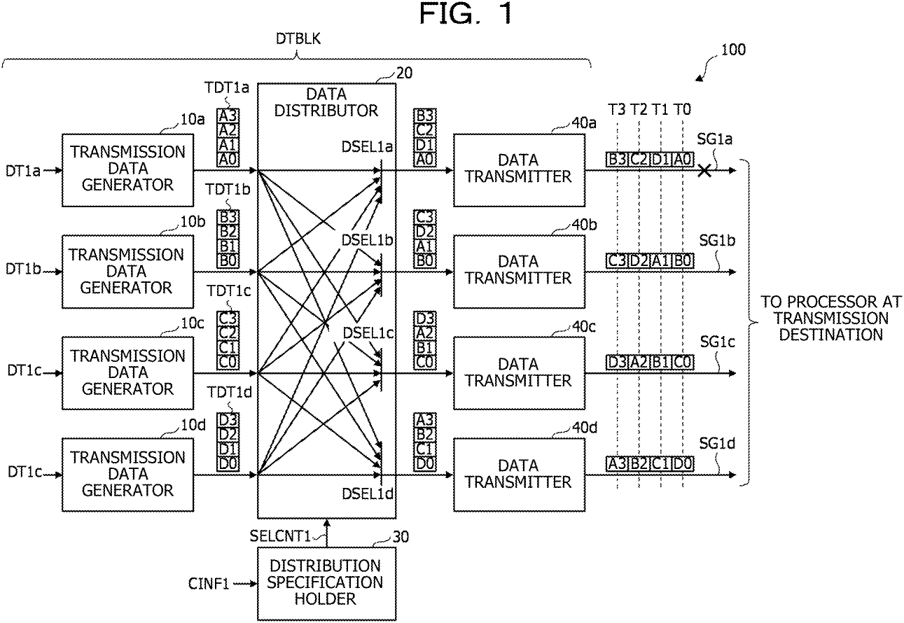

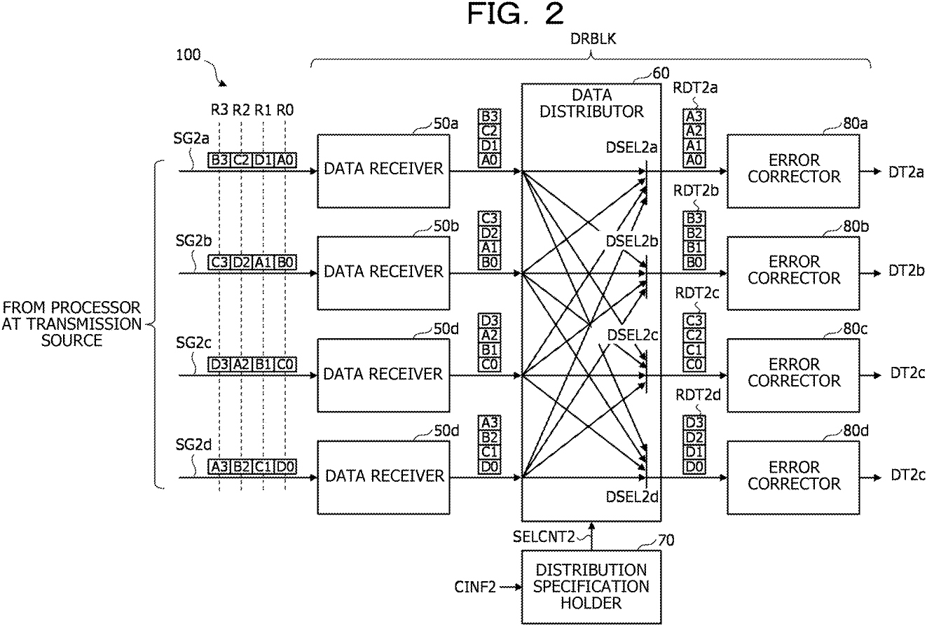

FIG. 1 illustrates an example of a data transmission block in a processor in one embodiment. For example, a processor 100 illustrated in FIG. 1 is, but not particularly limited to, a central processing unit (CPU). The processor 100 may include a data transmission block DTBLK and a data reception block DRBLK illustrated in FIG. 2.

The processor 100 may include multiple cores and caches, which are not illustrated, in addition to the elements illustrated in FIGS. 1 and 2. For example, a system may be constructed by multiple processors 100 including the data transmission block DTBLK illustrated in FIG. 1 and the data reception block DRBLK illustrated in FIG. 2. In this case, for example, the system may be in the form of a motherboard on which the multiple processors 100 to transmit and receive data to and from each other and a memory are mounted. The processor 100 mounted on the system may transmit and receive data to and from a processor 100 mounted in another system.

The data transmission block DTBLK includes multiple transmission data generators 10 (10a, 10b, 10c, and 10d), a data distributor 20, a distribution specification holder 30, and data transmitters 40 (40a, 40b, 40c, and 40d), the number of which is equal to the number of the transmission data generators 10. Each of the number of the transmission data generators 10 and the number of the data transmitters 40 is not limited to four, but may be any integer of two or more.

Each transmission data generator 10 generates transmission data TDT1 (TDT1a, TDT1b, TDT1c, or TDT1d) by adding an error correction code to transmission data DT1 (DT1a, DT1b, DT1c, or DT1d) transferred from the core or cache. Each transmission data generator 10 outputs the generated transmission data TDT1 to the data distributor 20. In this output, the transmission data generators 10 may output bit data pieces in the generated transmission data TDT1 in parallel to the data distributor 20.

The transmission data TDT1a includes bit data pieces A0, A1, A2, and A3. The transmission data TDT1b includes bit data pieces B0, B1, B2, and B3. The transmission data TDT1c includes bit data pieces C0, C1, C2, and C3. The transmission data TDT1d includes bit data pieces D0, D1, D2, and D3. Each of the transmission data TDT1a to TDT1d is an example of first transmission data. Each of the bit data pieces A0 to A3, B0 to B3, C0 to C3, and D0 to D3 is an example of a sub-data piece.

For example, with an error correction code, it is possible to correct an error in one bit and detect errors in two bits (single-error correction and double-error detection (SECDED)). In this embodiment, each transmission data TDT1 including the error correction code is assumed to have four bits, for convenience of the description. Actually, for example, the transmission data DT1 has 64 bits, and the transmission data TDT1 has 72 bits.

The data distributor 20 distributes the bit data pieces included in each of the transmission data TDT1a to TDT1d received from the transmission data generators 10a to 10d and transfers the distributed bit data pieces to the data transmitters 40a to 40d. For example, the data distributor 20 distributes the bit data pieces A0 to A3, B0 to B3, C0 to C3, and D0 to D3 in accordance with a selection control signal SELCNT1 so that the bit data pieces in each of the transmission data TDT1a to TDT1d are transferred to the different data transmitters 40a to 40d. The data distributor 20 is an example of a first data distributor.

For example, the data distributor 20 includes multiple data selectors DSEL1 (DSEL1a, DSEL1b, DSEL1c, and DSEL1d) respectively corresponding to the data transmitters 40 (40a to 40d). Each data selector DSEL1 is an example of a first data selector. Each data selector DSEL1 selects predetermined bit data pieces from the transmission data TDT1a to TDT1d transferred from the four transmission data generators 10 in accordance with the selection control signal SELCNT1, and transfers the selected bit data pieces to the corresponding data transmitter 40. In this transfer, the data selectors DSEL1 may transfer the selected bit data pieces in parallel to the respectively corresponding data transmitters 40.

In the example illustrated in FIG. 1, the data selector DSEL1a selects the bit data pieces A0, D1, C2, and B3. The data selector DSEL1b selects the bit data pieces B0, A1, D2, and C3. The data selector DSEL1c selects the bit data pieces C0, B1, A2, and D3. The data selector DSEL1d selects the bit data pieces D0, C1, B2, and A3.

The data selectors DSEL1a to DSEL1d perform operations of distributing the transmission data TDT1a to TDT1d received in common from the multiple transmission data generators 10, and transfer the distributed bit data pieces to the respectively corresponding data transmitters 40 in parallel. For this reason, the data transmitters 40a to 40d may transmit the transmission data TDT1a to TDT1d distributed to the bit data pieces to signal lines SG1a to SG1d at the same timings. As a result, even when each of the transmission data TDT1a to TDT1d is distributed into the bit data pieces, the processor 100 at a data transmission destination may correctly receive each of the transmission data TDT1a to TDT1d.

The data distributor 20 does not include a buffer or the like for temporarily holding the transmission data TDT1a to TDT1d. For this reason, the data distributor 20 may transfer the received transmission data TDT1a to TDT1d to the data transmitters 40 only with a delay caused by the data selectors DSEL1a to DSEL1d used for distribution. The data distributor 20 includes the simple data selectors DSEL1 each including a selector, a switch, or the like without including a buffer or the like. For this reason, the circuit scale of the data distributor 20 may be smaller than in a case where the data distributor 20 includes a buffer or the like. The latency of the transmission data output from the data distributor 20 may be shorter than in the case where the data distributor 20 includes a buffer or the like.

For example, in an initialization sequence for resetting the processor 100, the distribution specification holder 30 rewritably holds coupling information CINF1 transferred from a read-only memory (ROM) or the like (not illustrated) installed outside the processor 100. The distribution specification holder 30 outputs selection control signals SELCNT1 each having a predetermined logical value based on the held coupling information CINF1 to the respective data selectors DSEL1a to DSEL1d. The coupling information CINF1 held by the distribution specification holder 30 is an example of first distribution information describing specifications about how the data distributor 20 is to distribute the bit data pieces A0 to A3, B0 to B3, C0 to C3, and D0 to D3. The distribution specification holder 30 is an example of a first distribution specification holder.

Since the distribution specification holder 30 holds the coupling information CINF1 in a rewritable manner, it is possible to change the specifications about how the data selectors DSEL1a to DSEL1d are to distribute the bit data pieces depending on the specifications of the processor 100. After the processor 100 is mounted on the system, the specifications about how the data selectors DSEL1a to DSEL1d are to distribute bit data pieces may be changed. For example, in testing the processor 100 or testing the system, it is possible to transfer the transmission data TDT1a to TDT1d to the data transmitters 40a to 40d, respectively, while stopping the distribution of the bit data pieces by the data selectors DSEL1.

Each of the data transmitters 40 (40a to 40d) is coupled to a corresponding signal line SG1 (SG1a, SG1b, SG1c, or SG1d). The signal line SG1 is an example of a first signal line. In this embodiment, for example, each of the bit data pieces A0 to A3, B0 to B3, C0 to C3 and D0 to D3 has one bit, and each of the signal lines SG1a to SG1d includes a single signal wire. The total number of signal wires in the signal lines SG1a to SG1d is equal to the number of bits in each of the transmission data TDT1a to TDT1d.

For this reason, the data transmission block DTBLK may transmit the bit data pieces in each of the transmission data TDT1a to TDT1d by using the respectively different signal wires in the signal lines SG1a to SG1d. As a result, even when a permanent fault occurs in any of the signal wires in the signal lines SG1a to SG1d, a bit error occurring in each of the transmission data TDT1a to TDT1d may be only in one bit. When each of the bit data pieces A0 to A3, B0 to B3, C0 to C3, and D0 to D3 has n bits (n is an integer of two or more), the number of signal wires in each of the signal lines SG1 is n.

Each of the data transmitters 40 (40a to 40d) converts the bit data pieces transferred from the corresponding data selector DSEL1 (DSEL1a to DSEL1d) into serial data, and sequentially outputs the serial data to the corresponding signal line SG1. The bit data pieces sequentially output to the corresponding signal line SG1 by each data transmitter 40 are transferred to the processor 100 at the transmission destination. For example, each data transmitter 40 transmits the distributed multiple bit data pieces transferred from the data distributor 20 dividedly at multiple timings.

The data transmitters 40 transmit the bit data pieces (for example, A0 to A3) included in the transmission data TDT1 generated by each transmission data generator 10 to the corresponding signal lines SG1 at respectively different timings (cycles). For example, the data distributor 20 causes the data selectors DSEL1 to select bit data pieces such that the bit data pieces included in the transmission data TDT1 are distributed and transmitted to the signal line SG1 at different timings. This makes it possible to stop multiple bit errors due to, for example, the occurrence of a temporary defect such as noise from occurring in each transmission data TDT1 distributed to and transmitted via the multiple signal lines SG1.

The operation of distributing transmission data by the data distributor 20 and a data arrangement operation for transmitting the bit data pieces included in each transmission data TDT1 to the signal lines SG1 at different timings are preformed based on the coupling information CINF1. This makes it possible to stop the transmission data TDT1 generated by each transmission data generator 10 from concentrating in one signal line SG1. As a result, it is possible to stop multiple bit errors from occurring in each transmission data TDT1, which is a unit of error correction code generation, due to a permanent fault or the like in the signal wire in one of the signal lines SG1.

For example, in FIG. 1, a short-circuit failure or an open failure (indicated by X in FIG. 1) is occurring in the (single) signal wire in the signal line SG1a. For this reason, the bit data pieces A0, D1, C2, and B3 transferred to the processor 100 at the transmission destination via the signal line SG1a may include errors. However, an error occurs in just one bit in each of the transmission data TDT1a to TDT1d.

By stopping errors in multiple bits from occurring in each transmission data TDT1, the processor 100 that receives the data via the signal lines SG1 may detect errors in multiple bits included in the received data as 1-bit errors. The processor 100 that receives the data may correct the detected errors. As a result, the processor 100 that receives data does not have to be equipped with, for example, an error corrector that corrects errors in multiple bits, which makes it possible to reduce the circuit scale of the processor 100 and reduce the chip cost.

FIG. 2 illustrates an example of the data reception block DRBLK mounted on the processor 100 illustrated in FIG. 1. For example, the data reception block DRBLK illustrated in FIG. 2 is mounted not only on the processor 100 at the data transmission source but also on the processor 100 at the data transmission destination. For this reason, the following description will be given assuming that the data reception block DRBLK is mounted on the processor 100 at the data transmission destination.

The data reception block DRBLK includes multiple data receivers 50 (50a, 50b, 50c, and 50d), a data distributor 60, a distribution specification holder 70, and error correctors 80 (80a, 80b, 80c, and 80d). Each of the number of the data receivers 50 and the number of the error correctors 80 is not limited to four, but may be any integer of two or more.

Each data receiver 50 (50a, 50b, 50c, or 50d) sequentially receives bit data pieces from the processor 100 at the transmission source via the corresponding signal line SG2 (SG2a, SG2b, SG2c, or SG2d). The bit data pieces received by each data receiver 50 are an example of sub-data pieces, and the multiple bit data pieces include a distributed error correction code. Each data receiver 50 converts the bit data pieces sequentially received into parallel data and outputs the parallel data to the data distributor 60. The signal line SG2 is an example of a second signal line.

For example, the signal lines SG2a, SG2b, SG2c, and SG2d respectively correspond to the signal lines SG1a, SG1b, SG1c, and SG1d in FIG. 1, and each include a single signal wire. Each signal line SG2a, SG2b, SG2c, or SG2d receives bit data pieces transferred to the corresponding signal line SG1a, SG1b, SG1c, or SG1d in FIG. 1.

The data distributor 60 distributes the bit data pieces included in each of data received from the data receivers 50a to 50d and transfers the distributed bit data pieces to the error correctors 80a to 80d. For example, the data distributor 60 distributes the bit data pieces in accordance with a logical value in a selection control signal SELCNT2 so that the transmission data TDT1 generated by each transmission data generator 10 in the processor 100 at the transmission source will be restored. The data distributor 60 is an example of a second data distributor.

For example, the data distributor 60 includes multiple data selectors DSEL2 (DSEL2a to DSEL2d) respectively corresponding to the error correctors 80 (80a, 80b, 80c, and 80d). The data selector DSEL2 is an example of a second data selector. Each data selector DSEL2 selects predetermined bit data pieces in the data transferred from the four data receivers 50 in accordance with the selection control signal SELCNT2, and transfers the selected bit data pieces to the corresponding error corrector 80. In this transfer, the data selectors DSEL2 may transfer the selected bit data pieces in parallel to the corresponding error correctors 80.

In the example illustrated in FIG. 2, the data selector DSEL2a selects the bit data pieces A0 to A3 to restore, as received data RDT2a, the transmission data TDT1a generated by the transmission data generator 10a in FIG. 1. The data selector DSEL2b selects the bit data pieces B0 to B3 to restore, as received data RDT2b, the transmission data TDT1b generated by the transmission data generator 10b in FIG. 1.

The data selector DSEL2c selects the bit data pieces C0 to C3 to restore, as received data RDT2c, the transmission data TDT1c generated by the transmission data generator 10c in FIG. 1. The data selector DSEL2d selects the bit data pieces D0 to D3 to restore, as received data RDT2d, the transmission data TDT1d generated by the transmission data generator 10d in FIG. 1. The transmission data TDT1 generated by each transmission data generator 10 in FIG. 1 and the received data RDT2 (RDT2a, RDT2b, RDT2c, or RDT2d) restored by each data selector DSEL2 are an example of second transmission data.

The data selectors DSEL2a to DSEL2d perform operations of distributing the bit data pieces received in common from the multiple data receivers 50, and transfer the restored transmission data TDT1 to the respectively corresponding error correctors 80 in parallel. For this reason, the error correctors 80a and 80d are enabled to perform error correction on the restored transmission data TDT1a to TDT1d at the same timing.

The data distributor 60 does not include a buffer or the like for temporarily holding data received from the data receivers 50. For this reason, the data distributor 60 may transfer the received data to the error correctors 80 only with a delay caused by the data selectors DSEL2a to DSEL2d used for distribution. The data distributor 60 includes the simple data selectors DSEL2 each including a selector, a switch, or the like without including a buffer or the like. For this reason, the circuit scale of the data distributor 60 may be smaller than in a case where the data distributor 60 includes a buffer or the like.

For example, in an initialization sequence for resetting the processor 100, the distribution specification holder 70 rewritably holds coupling information CINF2 transferred from a ROM or the like (not illustrated) installed outside the processor 100. Based on the held coupling information CINF2, the distribution specification holder 70 outputs the selection control signal SELCNT2 having a predetermined logical value to each of the data selectors DSEL2a to DSEL2d. The coupling information CINF2 held by the distribution specification holder 70 is an example of second distribution information describing specifications about how the data distributor 60 is to distribute the bit data pieces received from the data receivers 50. The distribution specification holder 70 is an example of a second distribution specification holder.

Since the distribution specification holder 70 holds the coupling information CINF2 in a rewritable manner, it is possible to change the specifications about how the data selectors DSEL2a to DSEL2d are to distribute bit data pieces depending on the specifications of the processor 100. After the processor 100 is mounted on the system, the specifications about how the data selectors DSEL2a to DSEL2d are to distribute bit data pieces may be changed. For example, in testing the processor 100 or testing the system, it is possible to transfer the transmission data TDT1a to TDT1d to the error correctors 80 while stopping the distribution of the bit data pieces by the data selectors DSEL2 together with the data selectors DSEL1 in FIG. 1.

Each error corrector 80 (80a to 80d) detects whether or not there is an error in the received data RDT2 restored by the data distributor 60. When detecting no error, each error corrector 80 outputs the received data RDT2 to the cache or the core as received data DT2 (DT2a, DT2b, DT2c, or DT2d).

When detecting a 1-bit error in the received data RDT2, each error corrector 80 corrects the 1-bit error in the received data RDT2 by using the error correction code included in the received data RDT2 and outputs the corrected data as the received data DT2 to the cache or the core. When detecting errors in two or more bits in the received data RDT2, each of the error correctors 80 outputs error information indicating the occurrence of the uncorrectable errors to the core or a higher-level controller that manages the processor 100.

In the case where a failure occurs in the (single) signal wire in the signal line SG1a as illustrated in FIG. 1, all the bit data pieces A0, D1, C2, and B3 sequentially received via the signal wire in the signal line SG2a may be incorrect. In this case, a maximum of four bit errors occur in the four times of data transfers.

The bit data pieces A0, D1, C2, and B3 of four bits including the errors are distributed by the data distributor 60 and fed to the error correctors 80. For this reason, the error correctors 80 may detect the four bit errors sequentially occurring in the signal line SG1a as 1-bit errors in the received data RDT2 transferred from the data distributor 60, and correct the errors.

In contrast, in a processor that does not include the data distributors 20 and 60, a data transmission block DTBLK does not distribute the bit data pieces in transmission data TDT1 generated by each of the transmission data generators 10 but transmits the transmission data TDT1 to a processor at a transmission destination via the corresponding signal line SG1. For example, the data transmitter 40a outputs the bit data pieces A0 and A3 to the signal line SG1a.

A data reception block DRBLK receives the bit data pieces via the signal lines SG2 and corrects errors in the received data. For example, the data receiver 50a outputs the bit data pieces A0 to A3 received via the signal line SG2a to the error corrector 80a as the received data RDT2a. When detecting an error in two or more bits in the received data RDT2a, the error corrector 80a determines that the error is uncorrectable.

As described above, in this embodiment, the data distributor 20 distributes the bit data pieces included in the transmission data TDT1 generated by each of the transmission data generators 10, thereby stopping the transmission data TDT1 from concentrating in one signal line SG1. As a result, it is possible to stop errors in multiple bit data pieces from occurring in one transmission data TDT1, which is the unit of error correction code generation, due to a permanent fault in the signal wire in one of the signal lines SG1.

The data distributor 60 distributes the data received by the data receivers 50 to restore the transmission data TDT1a to TDT1d as the received data RDT2a to RDT2d. In this process, the bit data pieces A0, D1, C2, and B3 of four bits including the errors received via the signal line SG1a (= SG2a) are distributed by the data distributor 60 and fed to the error correctors 80. For this reason, the error correctors 80 may detect a maximum of four bit errors sequentially occurring in the signal line SG1a as 1-bit errors in the received data RDT2 transferred from the data distributor 60, and correct the errors.

Accordingly, the processor 100 including the data distributors 20 and 60 is capable of recovering data from bit errors from which a processor not including the data distributors 20 and 60 is uncapable of recovering data, thereby making it possible to improve the yield. As compared to a processor not including the data distributors 20 and 60, a system equipped with the processor 100 including the data distributors 20 and 60 may reduce the occurrence frequency of uncorrectable errors and improve the operation rate. As a result, it is possible to improve the reliability of the processor 100 and the system equipped with the processor 100. It is also possible to reduce the manufacturing cost of the processor 100 and reduce the operation cost of the system equipped with the processor 100.

The data distributor 20 causes the data selectors DSEL1 to select the bit data pieces such that the bit data pieces included in each of the transmission data TDT1 are distributed and transmitted to the signal lines SG1 at different timings. This makes it possible to stop multiple bit errors due to, for example, the occurrence of a temporary defect such as noise from occurring in one transmission data TDT1 that is distributed and transmitted to the multiple signal lines SG1.

The total number of the signal wires in the signal lines SG1a to SG1d is equal to the number of bits in each of the transmission data TDT1a to TDT1d. Accordingly, the bit data pieces in each of the transmission data TDT1a to TDT1d may be transmitted by using the respectively different signal wires in the signal lines SG1a to SG1d. As a result, even when a permanent fault occurs in any of the signal wires in the signal lines SG1a to SG1d, a bit error in each of the transmission data TDT1a to TDT1d may be only in one bit.

Since the distribution specification holder 30 holds the coupling information CINF1 in a rewritable manner, it is possible to change the specifications about how the data selectors DSEL1a to DSEL1d are to distribute the bit data pieces depending on the specifications of the processor 100. After the processor 100 is mounted on the system, the specifications about how the data selectors DSEL1a to DSEL1d are to distribute bit data pieces may be changed.

The data selectors DSEL1a to DSEL1d perform operations of distributing the transmission data TDT1a to TDT1d received in common from the multiple transmission data generators 10, and transfer the distributed bit data pieces to the respectively corresponding data transmitters 40 in parallel. For this reason, the data transmitters 40a to 40d may transmit the transmission data TDT1a to TDT1d distributed to the bit data pieces to signal lines SG1a to SG1d at the same timings. As a result, even when each of the transmission data TDT1a to TDT1d is distributed into the bit data pieces, the processor 100 at a data transmission destination may correctly receive each of the transmission data TDT1a to TDT1d.

Since the distribution specification holder 70 holds the coupling information CINF2 in a rewritable manner, it is possible to change the specifications about how the data selectors DSEL2a to DSEL2d are to distribute bit data pieces depending on the specifications of the processor 100. After the processor 100 is mounted on the system, the specifications about how the data selectors DSEL2a to DSEL2d are to distribute bit data pieces may be changed.

The data selectors DSEL2a to DSEL2d perform operations of distributing the bit data pieces received in common from the multiple data receivers 50, and transfer the restored transmission data TDT1 to the respectively corresponding error correctors 80 in parallel. For this reason, the error correctors 80a and 80d are enabled to perform error correction on the restored transmission data TDT1a to TDT1d at the same timing.

The data distributor 20 includes the simple data selectors DSEL1 each including a selector, a switch, or the like without including a buffer or the like. For this reason, the circuit scale of the data distributor 20 may be smaller than in a case where the data distributor 20 includes a buffer or the like. Similarly, the data distributor 60 includes the simple data selectors DSEL2 each including a selector, a switch, or the like without including a buffer or the like. For this reason, the circuit scale of the data distributor 60 may be smaller than in a case where the data distributor 60 includes a buffer or the like.

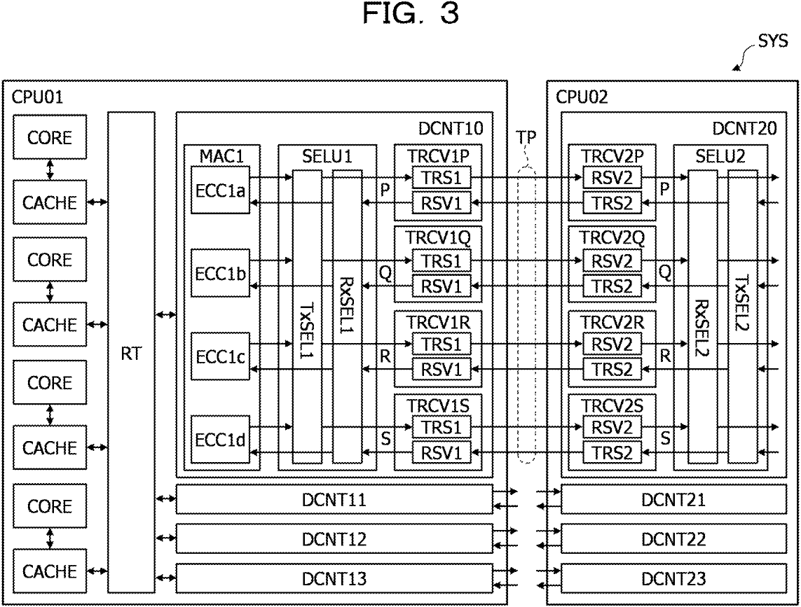

FIG. 3 illustrates an example of a system including a processor in another embodiment. The same elements as those illustrated in FIGS. 1 and 2 will be omitted from the detailed description. A system SYS illustrated in FIG. 3 includes multiple CPUs (CPU01 and CPU02). The CPU01 and the CPU02 have the same configuration and the same functions. For this reason, the configuration of the CPU01 will be mainly described below. Each of the CPU01 and the CPU02 is an example of a processor.

The CPU01 includes multiple cores CORE, multiple caches CACHE, a router RT, and multiple data control units DCNT1 (DCNT10, DCNT11, DCNT12, and DCNT13). The CPU02 includes data control units DCNT2 (DCNT20, DCNT21, DCNT22, and DCNT23) having the same configuration as that of the data control units DCNT1.

Each core CORE is coupled to the corresponding cache CACHE, and each cache CACHE is coupled to the router RT. The router RT couples the multiple cores CORE coupled via the multiple caches CACHE and the multiple data control units DCNT10 to DCNT13 to each other. The data control units DCNT10 to DCNT13 have the same configuration and functions. Thus, the data control unit DCNT10 will be described below.

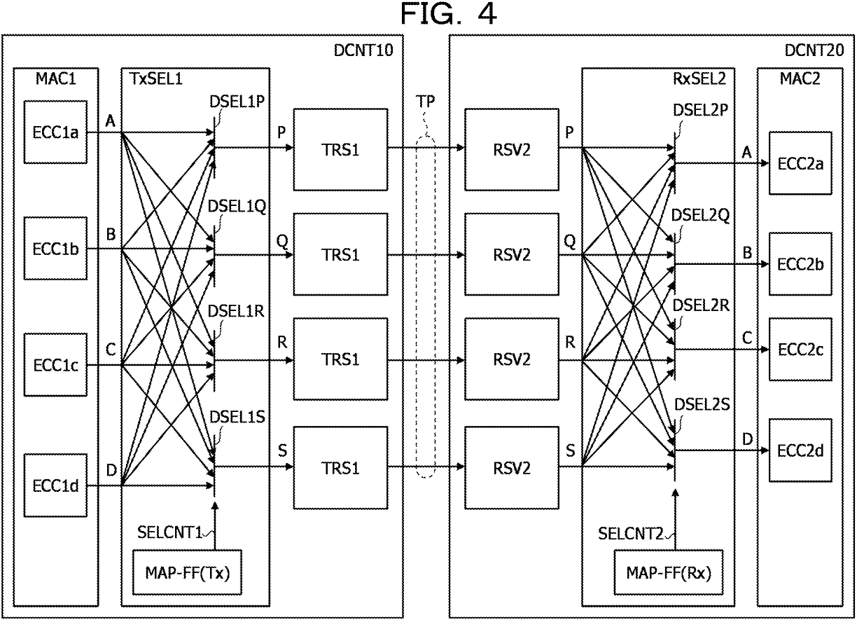

The data control unit DCNT10 includes a data link circuit MAC1 (MAC: media access control), a data selection block SBLK1, and multiple data transceivers TRCV1 (TRCV1P, TRCV1Q, TRCV1R, and TRCV1S). The data control unit DCNT20 includes multiple data transceivers TRCV2 (TRCV2P, TRCV2Q, TRCV2R, and TRCV2S), a data selection block SBLK2, and a not-illustrated data link circuit MAC2 (FIG. 4).

Each data transceiver TRCV1 includes a data transmitter TRS1 and a data receiver RSV1. Each data transceiver TRCV2 includes a data transmitter TRS2 and a data receiver RSV2. For example, each of the data transmitters TRS1 and TRS2 and the data receivers RSV1 and RSV2 is, but not particularly limited to, an analog transfer circuit which has an interface conforming to the high bandwidth memory (HBM) standard and which transfers data as an analog signal.

The data link circuit MAC1 includes multiple error correction control circuits ECC1 (ECC1a, ECC1b, ECC1c, and ECC1d). The data selection block SBLK1 includes a transmission data selection unit TxSEL1 and a received data selection unit RxSEL1. The data selection block SBLK2 of the data control unit DCNT20 includes a transmission data selection unit TxSEL2 and a received data selection unit RxSEL2.

Each error correction control circuit ECC1 has a function of generating an error correction code to be added to transmission data and a function of detecting and correcting an error in received data. Although not particularly limited, each error correction control circuit ECC1 adds an error correction code of 8 bits to each transmission data of 64 bits, and the error correction control circuits ECC1 output, in parallel, the respective transmission data of 72 bits including the error correction codes to the transmission data selection unit TxSEL1. A circuit that adds an error correction code to transmission data in each error correction control circuit ECC1 is an example of a transmission data generator.

Each error correction control circuit ECC1 detects an error in received data of 72 bits including the error correction code received from the received data selection unit RxSEL1. Each error correction control circuit ECC1 is capable of correcting an error in one bit and detecting errors in two bits included in the received data. A circuit that corrects an error in received data in each error correction control circuit ECC1 is an example of an error corrector.

The transmission data selection unit TxSEL1 distributes and transfers data received from each error correction control circuit ECC1 to the four data transmitters TRS1. The received data selection unit RxSEL1 distributes and transfers data received from each data receiver RSV1 to the four error correction control circuits ECC1.

For example, the transmission data selection unit TxSEL1 receives data of 288 bits (four 72-bit data) from the four error correction control circuits ECC1. For example, the received data selection unit RxSEL1 receives data of 288 bits (four 72-bit data) from the four data receivers RSV1. In the following description for convenience of the description, each of the transmission data selection unit TxSEL1 and the received data selection unit RxSEL1 is assumed to receive 256 bits (four 64-bit data). For example, the following description will be given assuming that an error correction code of 8 bits is absent.

Each data transmitter TRS1 is coupled to the data receiver RSV2 of another CPU02 via a corresponding signal line in a data transfer path TP. Each data receiver RSV1 is coupled to the data transmitter TRS2 of the other CPU02 via a corresponding signal line in the transfer path TP. Although not particularly limited, each data transmitter TRS1 transmits data to the corresponding data receiver RSV2 in parallel by using 16 signal lines provided in the transfer path TP. Each data transmitter TRS2 transmits data to the corresponding data receiver RSV1 in parallel by using 16 signal lines provided in the transfer path TP.

In FIG. 3, the 16 signal lines for transmitting data from each data transmitter TRS1 to the corresponding data receiver RSV2 are depicted by using a single arrow. The 16 signal lines for transmitting data from each data transmitter TRS2 to the corresponding data receiver RSV1 are depicted by a single arrow. In the case where data of 72 bits including an error correction code of 8 bits is transferred to the transfer path TP, each signal line depicted by a single arrow in FIG. 3 includes 18 signal lines. The signal lines coupling each data transmitter TRS1 and the corresponding data receiver RSV2 are examples of the first signal line and the second signal line. Similarly, the signal lines coupling each data transmitter TRS2 and the corresponding data receiver RSV1 are examples of the first signal line and the second signal line.

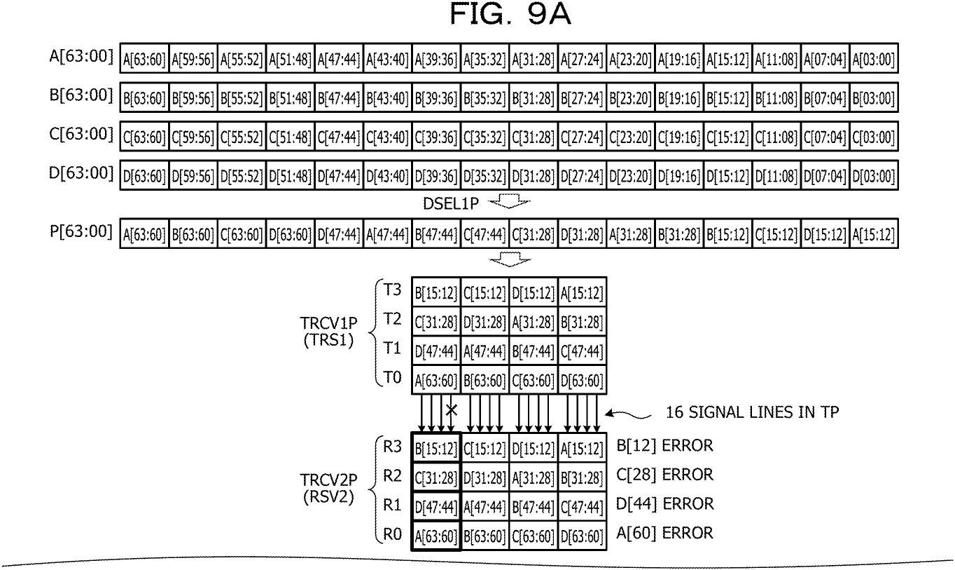

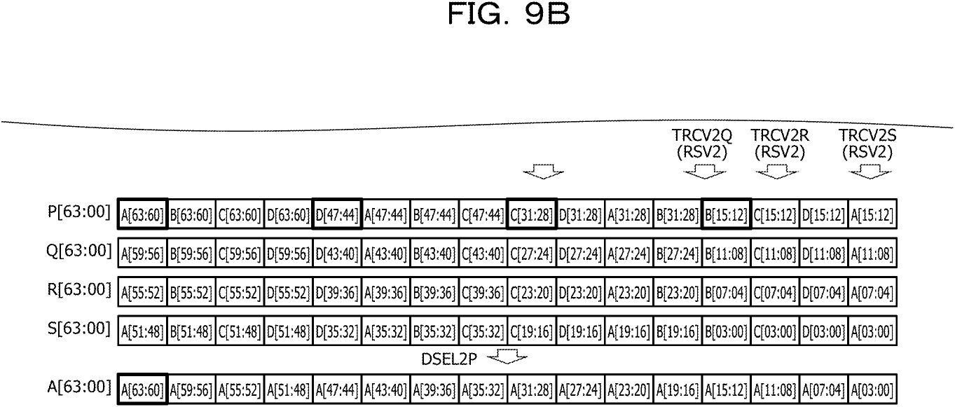

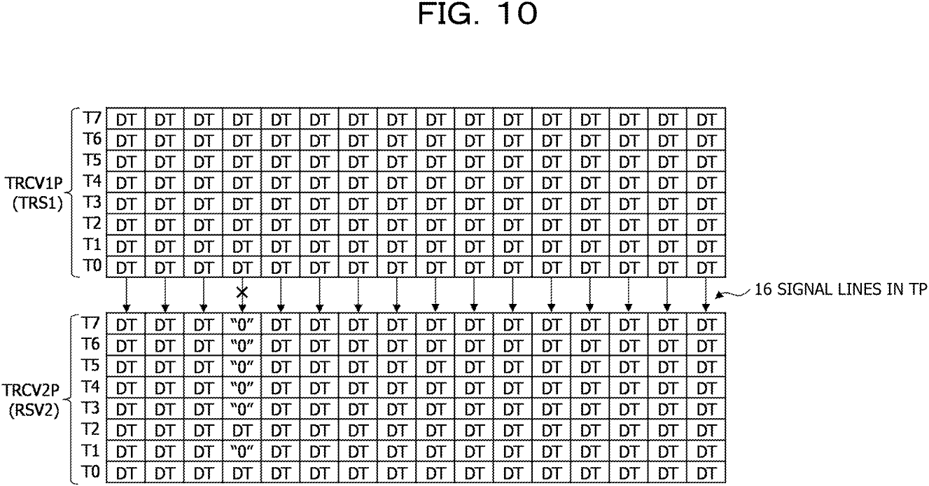

FIG. 4 illustrates an example of the data control units DCNT10 and DCNT20 in FIG. 3. In the data control unit DCNT10 illustrated in FIG. 4, the data receivers RSV1 and the received data selection unit RxSEL1 are omitted. In the data selector DCNT20 illustrated in FIG. 4, the transmission data selection unit TxSEL2 and the data transmitters TRS2 are omitted. A configuration of the received data selection unit RxSEL1 of the data control unit DCNT10 is the same as the configuration of the received data selection unit RxSEL2 of the data control unit DCNT20. A configuration of the transmission data selection unit TxSEL2 of the data control unit DCNT20 is the same as the configuration of the transmission data selection unit TxSEL1 of the data control unit DCNT10. Examples of operations of the data control units DCNT10 and DCNT20 are illustrated in FIGS. 9 to 13.

Each of the error correction control circuits ECC1a to ECC1d in the data control unit DCNT10 outputs transmission data (A, B, C or D) to which an error correction code is added to the transmission data selection unit TxSEL1. The transmission data A, B, C, or D output by each of the error correction control circuits ECC1a to ECC1d is an example of first transmission data.

The transmission data selection unit TxSEL1 of the data control unit DCNT10 includes multiple data selectors DSEL1 (DSEL1P, DSEL1Q, DSEL1R, and DSEL1S) respectively corresponding to the error correction control circuits ECC1 (ECC1a to ECC1d). The transmission data selection unit TxSEL1 includes a flip-flop MAP-FF (Tx) that holds coupling information and outputs a selection control signal SELCNT1 having a predetermined logical value to each of the data selectors DSEL1 based on the held coupling information. The flip-flop MAP-FF (Tx) may be provided in common to the data control units DCNT10, DCNT11, DCNT12, and DCNT13 illustrated in FIG. 3. The flip-flop MAP-FF (Tx) is an example of a first distribution specification holder that holds distribution information describing specifications about how the transmission data selection unit TxSEL1 is to distribute transmission data.

Each data selector DSEL1 selects predetermined bit data pieces (sub-data pieces) from the transmission data A, B, C, and D transferred from the error correction control circuits ECC1a to ECC1d in accordance with the selection control signal SELCNT1. Each data selector DSEL1 transfers transmission data (P, Q, R or S) including the selected bit data pieces to the corresponding data transmitter TRS1. Each data selector DSEL1 is an example of a first data distributor that distributes and transfers multiple sub-data pieces included in each of the transmission data A, B, C, and D to the multiple data transmitters TRS1.

For example, the number of bits in each of the transmission data P, Q, R, and S is equal to the number of bits in each of the transmission data A, B, C, and D transferred from the error correction control circuits ECC1 (for example, 64 bits). For example, the data selectors DSEL1 output the transmission data P, Q, R, and S in parallel.

Each data transmitter TRS1 of the data control unit DCNT10 is coupled to the corresponding data receiver RSV2 via the transfer path TP. Each data transmitter TRS1 transmits, to the corresponding data receiver RSV2, the transmission data (P, Q, R or S) including distributed sub-data pieces of the transmission data A, B, C, and D.

The data control unit DCNT20 includes a data link circuit MAC2 having the same circuit configuration and functions as those of the data link circuit MAC1 of the data control unit DCNT10. The data link circuit MAC2 includes multiple error correction control circuits ECC2 (ECC2a, ECC2b, ECC2c, and ECC2d). A circuit configuration and functions of each error correction control circuit ECC2 are the same as the circuit configuration and the functions of the error correction control circuit ECC1. A circuit that corrects an error in received data in each error correction control circuit ECC2 is an example of an error corrector.

Each data receiver RSV2 of the data control unit DCNT20 outputs data received from the corresponding data transmitter TRS1 as received data (P, Q, R or S) to the received data selection unit RxSEL2.

The received data selection unit RxSEL2 of the data control unit DCNT20 includes multiple data selectors DSEL2 (DSEL2P, DSEL2Q, DSEL2R, and DSEL2S) respectively corresponding to the error correction control circuits ECC2a to ECC2d. The received data selection unit RxSEL2 includes a flip-flop MAP-FF (Rx) that holds coupling information and outputs a selection control signal SELCNT2 having a predetermined logical value to each data selector DSEL2 based on the held coupling information. The flip-flop MAP-FF (Rx) may be provided in common to the data control units DCNT20, DCNT21, DCNT22, and DCNT23 illustrated in FIG. 3. The flip-flop MAP-FF (Rx) is an example of a second distribution specification holder that holds distribution information describing specifications about how the received data selection unit RxSEL2 is to distribute received data.

Each data selector DSEL2 receives the received data P, Q, R, and S transferred from the four data receivers RSV2. Each data selector DSEL2 distributes predetermined bit data pieces included in the received data P, Q, R, and S in accordance with the selection control signal SELCNT2, and transfers the predetermined bit data pieces to the corresponding error correction control circuit ECC2 (one of ECC2a to ECC1d). For example, the data selectors DSEL2 distribute the received data P, Q, R, and S to restore the transmission data A, B, C, and D that are the second transmission data generated by the respective error correction control circuits ECC1 of the data control unit DCNT10. Each data selector DSEL2 is an example of a second data distributor that distributes multiple sub-data pieces included in each of the received data P, Q, R, and S to restore the transmission data A, B, C, or D.

Each error correction control circuit ECC2 of the data control unit DCNT20 corrects an error in data (A, B, C or D) restored by the received data selection unit RxSEL2. Each error correction control circuit ECC2 is capable of correcting an error in one bit and detecting errors in two bits included in the received data (A, B, C or D).

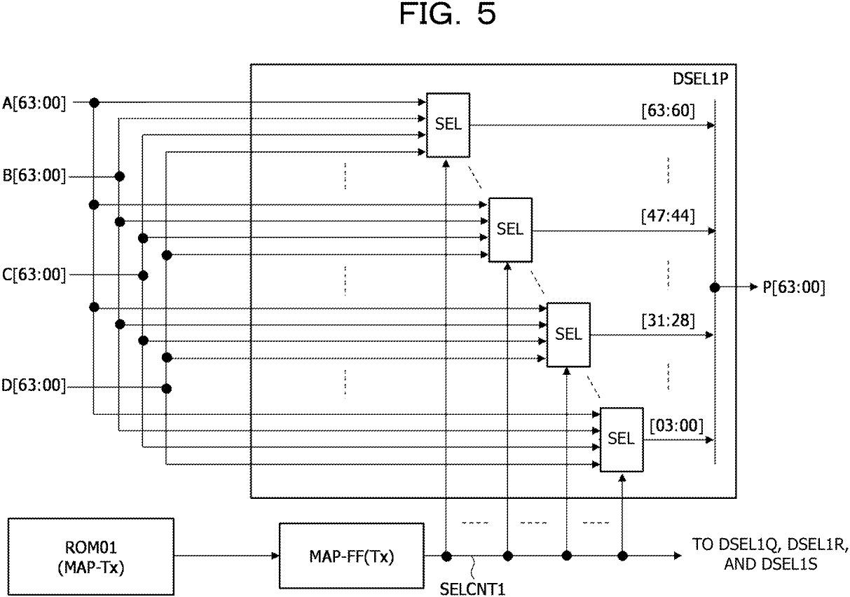

FIG. 5 illustrates an example of the data selector DSEL1P of the transmission data selection unit TxSEL1 illustrated in FIG. 4. Circuit configurations of the data selectors DSEL1Q, DSEL1R, and DSEL1S in FIG. 4 are the same as the circuit configuration of the data selector DSEL1P except that the received selection control signals SELCNT1 have different logical values.

The data selector DSEL1P receives 16 bits from each of the data A [63:00], B [63:00], C [63:00], and D [63:00] of 256 bits transferred from the four error correction control circuits ECC1. The data selector DSEL1P includes 16 selectors SEL each of which selects four bits from the received data A, B, C, and D (each including 16 bits). Each selector SEL transfers the four bits selected in accordance with the selection control signal SELCNT1 output from the flip-flop MAP-FF (Tx) to the corresponding data transmitter TRS1.

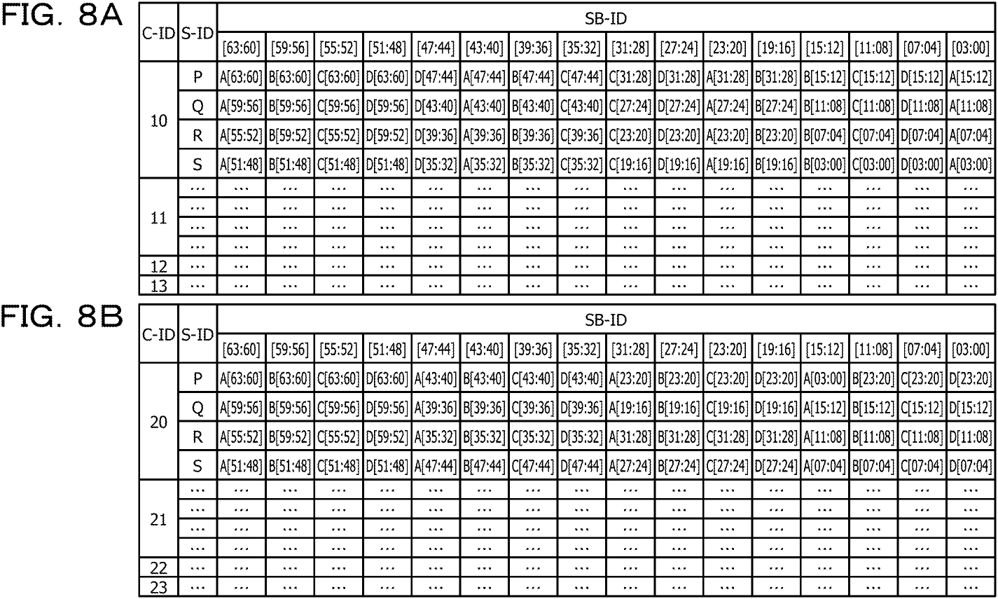

Each of the other data selectors DSEL1Q, DSEL1R, and DSEL1S also receives 16 bits from each of the data A [63:00], B [63:00], C [63:00], and D [63:00] of 256 bits and includes 16 selectors SEL each of which selects four bits from the received data. The logical values of the selection control signals SELCNT1 are set such that 64 bits selected by each of the data selectors DSEL1P, DSEL1Q, DSEL1R, and DSEL1S are different from those of the other data selectors. An example of bits of the data A, B, C, and D selected by the transmission data selection unit TxSEL1 in FIG. 4 is illustrated in FIG. 8.

The coupling information to be held by the flip-flop MAP-FF (Tx) is transferred from the ROM 01 to the flip-flop MAP-FF (Tx) in an initialization sequence for resetting the CPU01. For example, a serial interface such as Joint Test Action Group (JTAG) may be used to transfer the coupling information from the ROM 01 to the flip-flop MAP-FF (Tx).

The ROM 01 holds map information MAP (Tx) as the coupling information. For example, both the ROM 01 and the CPU01 are together mounted on a motherboard. Because the coupling information is transferred from the outside of the CPU01, the CPU01 does not have to include a built-in static random-access memory (SRAM) or the like for storing the coupling information. For example, the CPU01 may store the coupling information in the flip-flop MAP-FF (Tx) having a gate scale smaller than that of an SRAM memory cell. As a result, the circuit scale of the data control unit DCNT10 may be smaller than in the case where the data control unit DCNT10 includes a built-in SRAM or the like that stores the coupling information.

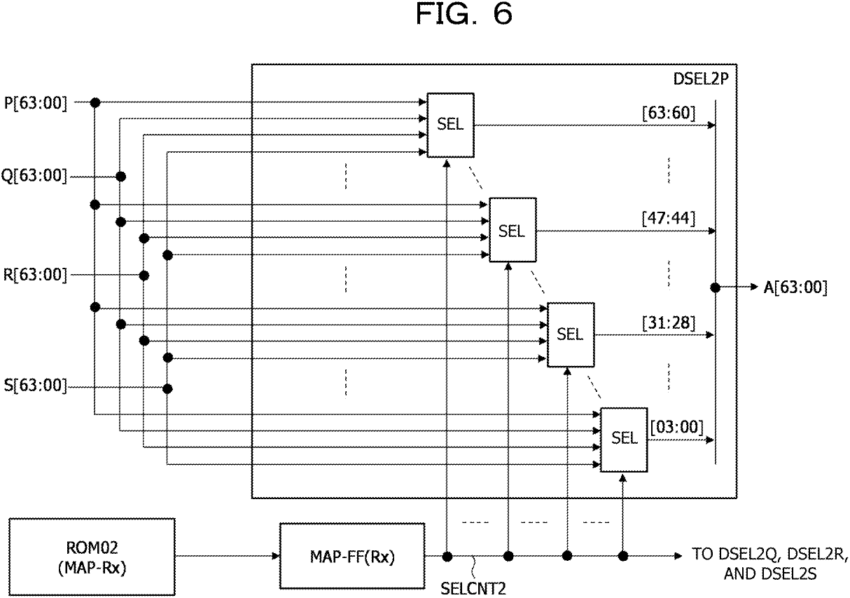

FIG. 6 illustrates an example of the data selector DSEL2P of the received data selection unit RxSEL2 in FIG. 4. Circuit configurations of the data selectors DSEL2Q, DSEL2R, and DSEL2S in FIG. 4 are the same as the circuit configuration of the data selector DSEL2P except that the received selection control signals SELCNT2 have different logical values.

The data selector DSEL2P receives 16 bits from each of the data P [63:00], Q [63:00], R [63:00], and S [63:00] of 256 bits transferred from the four data receivers RSV2. The data selector DSEL2P includes 16 selectors SEL each of which selects four bits from the received data P, Q, R, and S (each including 16 bits). Each selector SEL transfers, to the corresponding error correction control circuit ECC2, the four bits selected in accordance with the selection control signal SELCNT2 output from the flip-flop MAP-FF (Rx).

Each of the other data selectors DSEL2Q, DSEL2R, and DSEL2S also receives 16 bits from each of the data P [63:00], Q [63:00], R [63:00], and S [63:00] of 256 bits and includes 16 selectors SEL each of which selects four bits from the received data. The logical values of the selection control signals SELCNT2 are set such that 64 bits selected by each of the data selectors DSEL2P, DSEL2Q, DSEL2R, and DSEL2S are different from those of the other data selectors. An example of bits of the data P, Q, R, and S selected by the received data selection unit RxSEL2 in FIG. 4 is illustrated in FIG. 8.

The coupling information to be held by the flip-flop MAP-FF (Rx) is transferred from the ROM 02 to the flip-flop MAP-FF (Rx) in an initialization sequence for resetting the CPU02. For example, a serial interface such as JTAG may be used to transfer the coupling information from the ROM 02 to the flip-flop MAP-FF (Rx).

The ROM 02 holds map information MAP (Rx) as the coupling information. For example, both the ROM 02 and the CPU02 are together mounted on a motherboard. Since the coupling information is transferred from the outside of the CPU02, the CPU02 does not have to include a built-in static SRAM or the like for storing the coupling information. For example, the CPU02 may store the coupling information in the flip-flop MAP-FF (Rx) having a gate scale smaller than that of an SRAM memory cell. As a result, the circuit scale of the data control unit DCNT20 may be smaller than in a case where the data control unit DCNT20 includes a built-in SRAM or the like that stores the coupling information.

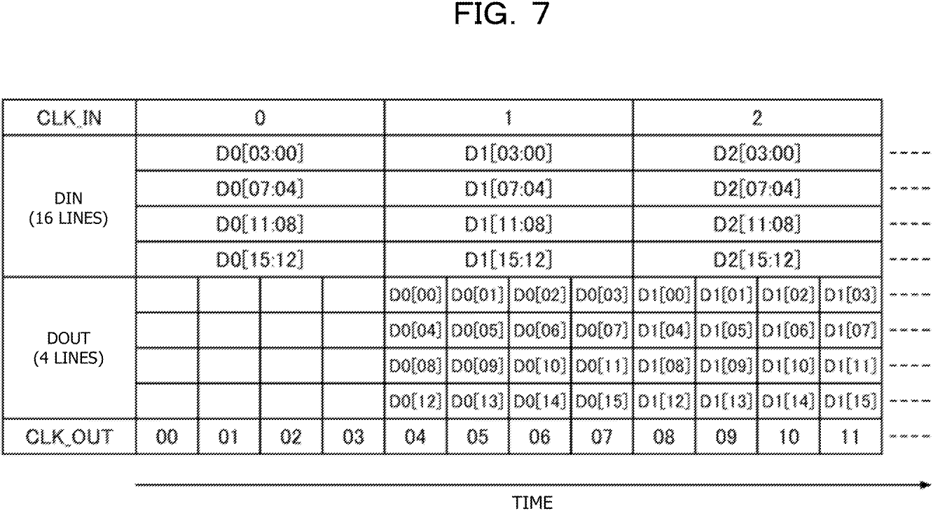

FIG. 7 illustrates an example of an operation of transmitting data of 16 bits by the data transmitter TRS1 in FIG. 3. Reference sign DIN indicates 16 data input terminals of the data transmitter TRS1. Reference sign DOUT indicates four data output terminals of the data transmitter TRS1.

In this embodiment, the clock frequency on the output side of the data transmitter TRS1 is four times the clock frequency on the input side of the data transmitter TRS1. For this reason, one cycle of an input clock CLK_IN in the data transmitter TRS1 is equal to four cycles of an output clock CLK_OUT in the data transmitter TRS1.

The data transmitter TRS1 receives data D0 of 16 bits in the cycle 0 of the input clock CLK_IN and outputs the received data D0 of 16 bits in the cycle 1 of the input clock CLK_IN. In this output, the data transmitter TRS1 outputs four bits of the data D0 in each of the four cycles 04, 05, 06, and 07 of the output clock CLK_OUT.

As illustrated in FIG. 7, the data transmitter TRS1 executes so-called quad data rate (QDR) transfer in which data is output at a clock rate four times the clock rate of the input clock CLK_IN by using the data output terminals the number of which is one fourth of the number of the data input terminals. Accordingly, it is possible to design a highly reliable circuit for the data transmitter TRS1 by using the existing QDR transfer technique while saving the design period and the design cost.

FIGS. 8A and 8B are explanatory diagrams illustrating examples of data selection specifications for the transmission data selection unit TxSEL1 and the received data selection unit RxSEL2 in FIG. 4. Reference sign C-ID of the transmission data selection unit TxSEL1 in FIF. 8A indicates a numerical value (identifier) in the suffix of the data control unit DCNT10, DCNT11, DCNT12, or DCNT13 in FIG. 3. Reference sign S-ID of the transmission data selection unit TxSEL1 in FIG. 8A indicates an alphabet (identifier) in the suffix of the data selector DSEL1P, DSEL1Q, DSEL1R, or DSEL1S in FIG. 4. Reference sign SB-ID of the transmission data selection unit TxSEL1 indicates data of four bits selected by each of the 16 selectors SEL (FIG. 5) of each data selector DSEL1P, DSEL1Q, DSEL1R, or DSEL1S of the transmission data selection unit TxSEL1.

Reference sign C-ID of the received data selection unit RxSEL2 in FIG. 8B indicates a numerical value (identifier) in the suffix of the data control unit DCNT20, DCNT21, DCNT22, or DCNT23 in FIG. 3. Reference sign S-ID of the received data selection unit RxSEL2 in FIG. 8B indicates an alphabet (identifier) in the suffix of the data selector DSEL2P, DSEL2Q, DSEL2R, or DSEL2S in FIG. 4. Reference sign SB-ID in the received data selection unit RxSEL2 indicates data of four bits selected by each of the 16 selectors SEL (FIG. 6) in the received data selection unit RxSEL2.

FIGS. 9A and 9B illustrate, as a whole, an example of a data transmission-reception operation (1) between the data control units DCNT10 and DCNT20 in FIG. 3. In the operation illustrated in FIGS. 9A and 9B, 64 bits of data are transferred from the data transceiver TRCV1P to the data transceiver TRCV2P in FIG. 3.

The data selector DSEL1P of the transmission data selection unit TxSEL1 in FIG. 4 selects predetermined 64 bits from 256 bits of the data A [63:00], B [63:00], C [63:00], and D [63:00]. In this selection, the data selector DSEL1P selects 64 bits of data composed of 16 bits in the data A, 16 bits in the data B, 16 bits in the data C, and 16 bits in the data D from the 256 bits of data. The data selector DSEL1P transfers the selected 64 bits of data as data P [63:0] to the data transmitter TRS1 of the data transceiver TRCV1P.

The data transmitter TRS1 transmits the 64 bits of data dividedly at four timings to the data receiver RSV2 via the 16 signal lines of the transfer path TP (QDR transfer). It is assumed that one of the 16 signal lines indicated by an X sign has a permanent fault. For this reason, there is a possibility that errors occur in a maximum of four bits of data A [60], D [44], C [28], and B [12] among the 64 bits transmitted dividedly in the 16-bit units. For example, in a case where a “0” permanent fault occurs in a signal line, an error occurs in data associated with the logical value of 1 among the data A [60], D [44], C [28], and B [12]. In FIGS. 9A, 9B and 11A to 14, four bits of data that may include an error are indicated by a thick frame.

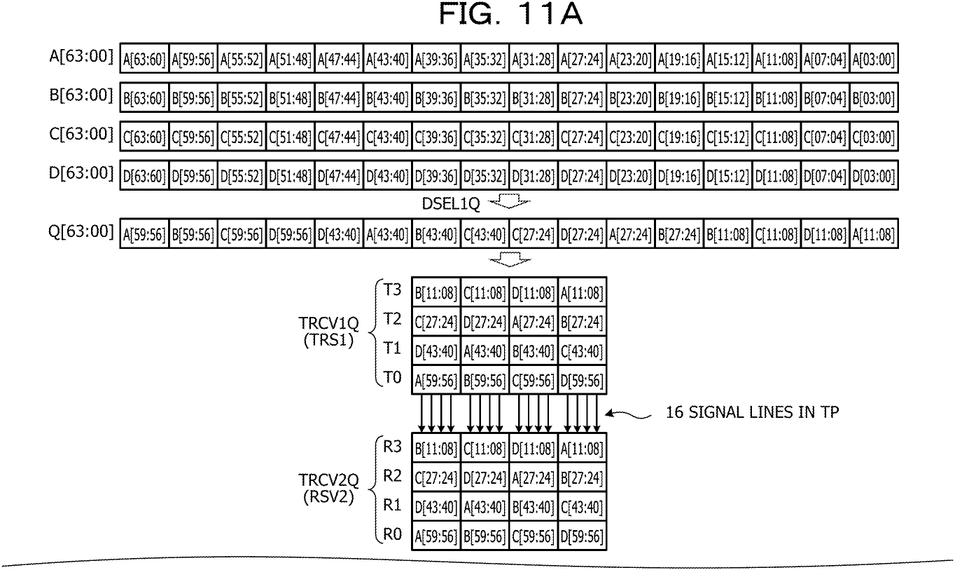

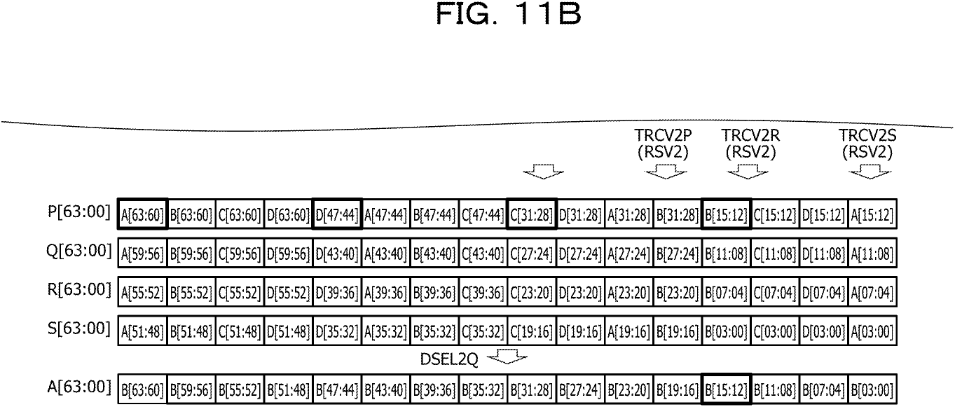

The data receiver RSV2 of the data transceiver TRCV2P sequentially receives, dividedly at four timings, 64 bits of data transmitted from the data transceiver TRCV1P and outputs the received data to the received data selection unit RxSEL2. As illustrated in FIGS. 11A and 11B, the data receiver RSV2 of the data transceiver TRCV2Q sequentially receives, dividedly at four timings, 64 bits of data transmitted from the data transceiver TRCV1Q and outputs the received data to the received data selection unit RxSEL2.

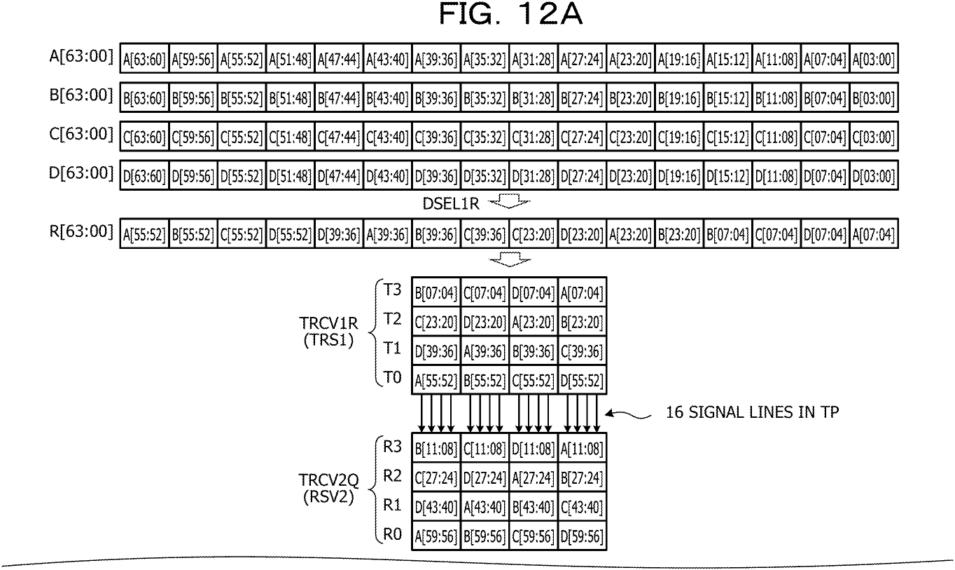

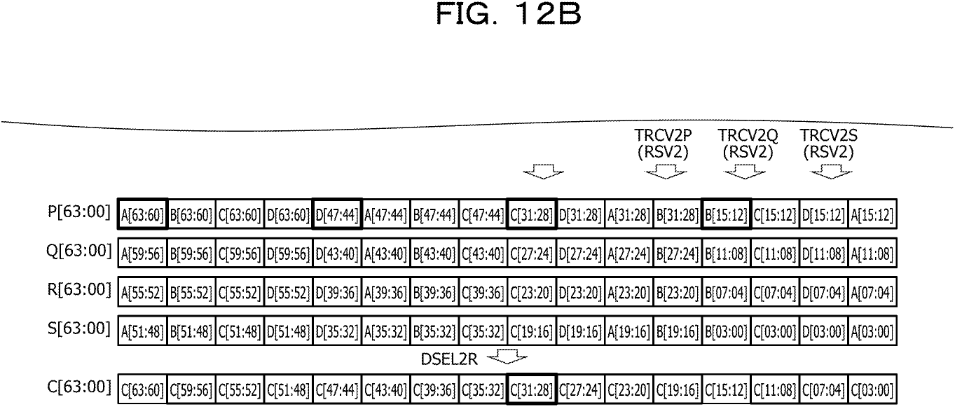

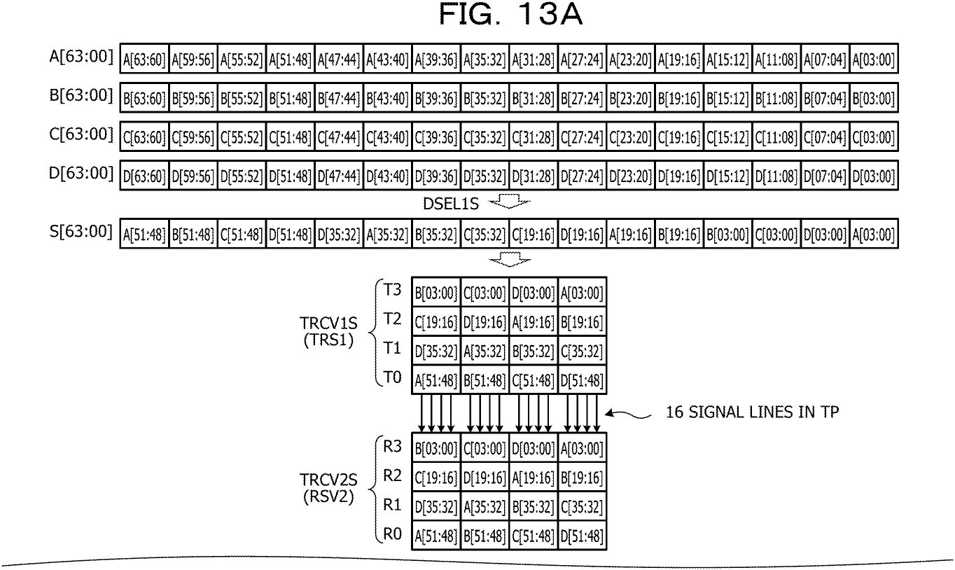

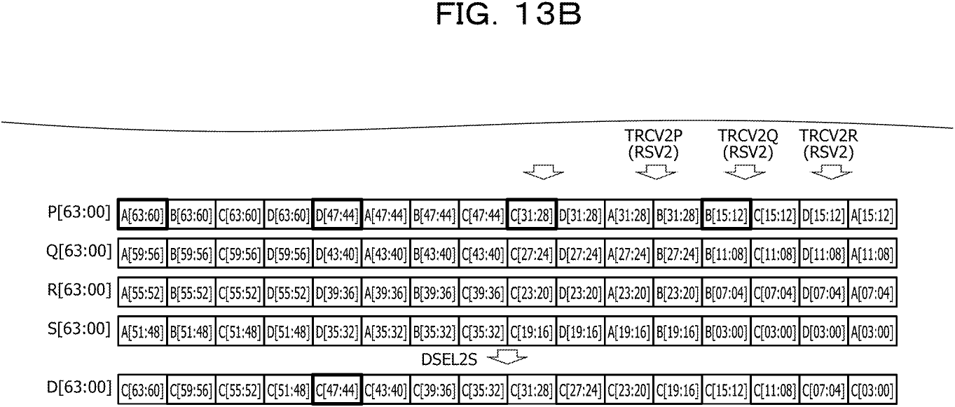

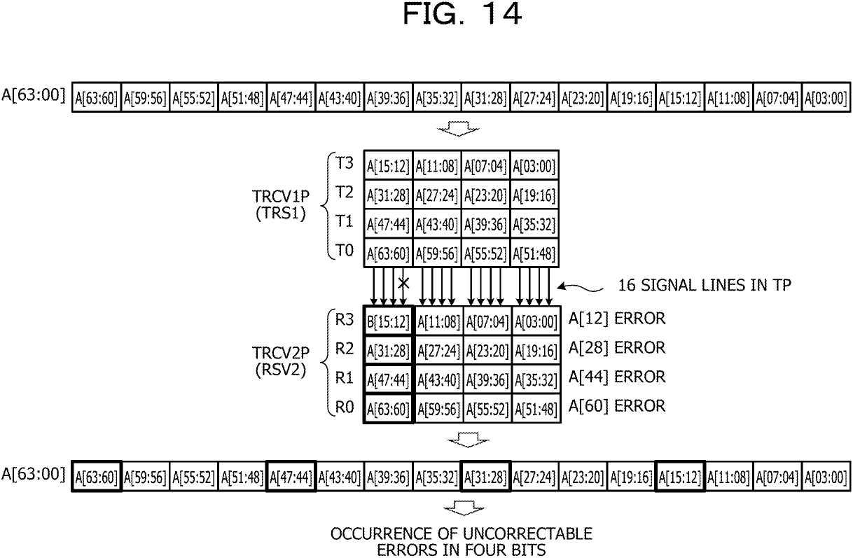

As illustrated in FIGS. 12A and 12B, the data receiver RSV2 of the data transceiver TRCV2R sequentially receives, dividedly at four timings, 64 bits of data transmitted from the data transceiver TRCV1R and outputs the received data to the received data selection unit RxSEL2. As illustrated in FIGS. 13A and 13B, the data receiver RSV2 of the data transceiver TRCV2S sequentially receives, dividedly at four timings, 64 bits of data transmitted from the data transceiver TRCV1S and outputs the received data to the received data selection unit RxSEL2.

The data selector DSEL2P of the received data selection unit RxSEL2 in FIG. 4 selects the data A [63:00] from among the 256 bits of data received by the data receivers RSV2. As a result, the data A [63:00] of 64 bits generated by the error correction control circuit ECC1a of the data control unit DCNT10 are restored. However, one bit (the data piece A [60]) in the data A [63:00] may include an error in some cases. However, in the data link circuit MAC2 in FIG. 4, the error correction control circuit ECC2a that receives A [63:00] from the data selector DSEL2P is capable of correcting a 1-bit error when detecting the 1-bit error.

FIG. 10 illustrates an example of the occurrence of bit errors in the operation illustrated in FIGS. 9A and 9B. FIG. 10 illustrates an operation for eight cycles in each of which 16 bits of data DT are transmitted from the data transceiver TRCV1P to the data transceiver TRCV2P. In the cycles T0 to T2, a “0” permanent fault is about to occur in the data DT at the fourth most significant bit, and an error occurs in one cycle but does not occur in the other cycles. In the cycles T3 to T7, a complete “0” permanent fault occurs, and the data DT at the fourth most significant bit is fixed to “0”.

FIGS. 11A and 11B, illustrate, as a whole, an example of a data transmission-reception operation (2) between the data control units DCNT10 and DCNT20 in FIG. 3. Detailed description of the same operation as in FIGS. 9A and 9B will be omitted. In the operation illustrated in FIGS. 11A and 11B, 64 bits of data are transferred from the data transceiver TRCV1Q to the data transceiver TRCV2Q in FIG. 3.

As in FIGS. 9A and 9B, the data selector DSEL1Q of the transmission data selection unit TxSEL1 in FIG. 4 selects predetermined 64 bits from the 256 bits of the data A [63:00], B [63:00], C [63:00], and D [63:00]. The data selector DSEL1Q transfers the selected 64 bits of data as data Q [63:0] to the data transmitter TRS1 of the data transceiver TRCV1Q. As in FIGS. 9A and 9B, the data transmitter TRS1 transmits the 64 bits of data to the data receiver RSV2 dividedly at four timings. It is assumed that the 16 signal lines coupled between the data transceivers TRCV1Q and TRCV2Q are different from the 16 signal lines coupled between the data transceivers TRCV1P and TRCV2P, and have no permanent fault.

The data receiver RSV2 of the data transceiver TRCV2Q sequentially receives, dividedly at four timings, the 64 bits of data transmitted from the data transceiver TRCV1Q and outputs the received data to the received data selection unit RxSEL2.

The data selector DSEL2Q of the received data selection unit RxSEL2 in FIG. 4 selects the data B [63:00] from the 256 bits of data received by the data receivers RSV2. As a result, the data B [63:00] of 64 bits generated by the error correction control circuit ECC1b of the data control unit DCNT10 are restored. In the data link circuit MAC2 in FIG. 4, the error correction control circuit ECC2b that receives the data B [63:00] from the data selector DSEL2Q detects that there is no error in the data B [63:00].

FIGS. 12A and 12B illustrate, as a whole, an example of a data transmission-reception operation (3) between the data control units DCNT10 and DCNT20 in FIG. 3. Detailed description of the same operation as in FIGS. 9A and 9B will be omitted. In the operation illustrated in FIGS. 12A and 12B, 64 bits of data are transferred from the data transceiver TRCV1R to the data transceiver TRCV2R in FIG. 3.

As in FIGS. 9A and 9B, the data selector DSEL1R of the transmission data selection unit TxSEL1 in FIG. 4 selects predetermined 64 bits from the 256 bits of the data A [63:00], B [63:00], C [63:00], and D [63:00]. The data selector DSEL1R transfers the selected 64 bits of data as data R [63:0] to the data transmitter TRS1 of the data transceiver TRCV1R. As in FIGS. 9A and 9B, the data transmitter TRS1 transmits the 64 bits of data to the data receiver RSV2 dividedly at four timings. It is assumed that the 16 signal lines coupled between the data transceivers TRCV1R and TRCV2R are different from the 16 signal lines coupled between the data transceivers TRCV1P and TRCV2P, and have no permanent fault.

The data receiver RSV2 of the data transceiver TRCV2R sequentially receives, dividedly at four timings, the 64 bits of data transmitted from the data transceiver TRCV1R and outputs the received data to the received data selection unit RxSEL2.

The data selector DSEL2R of the received data selection unit RxSEL2 in FIG. 4 selects the data C [63:00] from among the 256 bits of data received by the data receivers RSV2. As a result, the data C [63:00] of 64 bits generated by the error correction control circuit ECC1c of the data control unit DCNT10 are restored. In the data link circuit MAC2 in FIG. 4, the error correction control circuit ECC2c that receives the data C [63:00] from the data selector DSEL2R detects that there is no error in the data C [63:00].

FIGS. 13A and 9B illustrate, as a whole, an example of a data transmission-reception operation (4) between the data control units DCNT10 and DCNT20 in FIG. 3. Detailed description of the same operation as in FIGS. 9A and 9B will be omitted. In the operation illustrated in FIGS. 13A and 13B, 64 bits of data are transferred from the data transceiver TRCV1S to the data transceiver TRCV2S in FIG. 3.

As in FIGS. 9A and 9B, the data selector DSEL1S of the transmission data selection unit TxSEL1 in FIG. 4 selects predetermined 64 bits from the 256 bits of the data A [63:00], B [63:00], C [63:00], and D [63:00]. The data selector DSEL1S transfers the selected 64 bits of data as data S [63:0] to the data transmitter TRS1 of the data transceiver TRCV1S. As in FIGS. 9A and 9B, the data transmitter TRS1 transmits the 64 bits of data to the data receiver RSV2 dividedly at four timings. It is assumed that the 16 signal lines coupled between the data transceivers TRCV1S and TRCV2S are different from the 16 signal lines coupled between the data transceivers TRCV1P and TRCV2P, and have no permanent fault.

The data receiver RSV2 of the data transceiver TRCV2S sequentially receives, dividedly at four timings, the 64 bits of data transmitted from the data transceiver TRCV1S and outputs the received data to the received data selection unit RxSEL2.

The data selector DSEL2S of the received data selection unit RxSEL2 in FIG. 4 selects the data D [63:00] from among the 256 bits of data received by the data receivers RSV2. As a result, the data D [63:00] of 64 bits generated by the error correction control circuit ECC1d of the data control unit DCNT10 are restored. In the data link circuit MAC2 in FIG. 4, the error correction control circuit ECC2d that receives the data D [63:00] from the data selector DSEL2S detects that there is no error in the data D [63:00].

The transmission data selection unit TxSEL1 of the data control unit DCNT10 transmits the data A, B, C, and D to the data control unit DCNT20 in the distributed manner as described with reference to FIGS. 9A to 13B. The received data selection unit RxSEL2 of the data control unit DCNT20 restores the data A, B, C, and D from the distributed data. In this way, errors in four bits that occur in the transfer path TP may be distributed such that a 1-bit error occurs in each of the restored data A, B, C, and D. As a result, it is possible to detect and correct 1-bit errors in the data that sequentially occur due to a failure in any of the signal lines of the transfer path TP.

FIG. 14 illustrates an example of a transmission-reception operation by another processor that does not include the transmission data selection unit TxSEL1 and the received data selection unit RxSEL2 illustrated in FIG. 4. The processor that executes the operation illustrated in FIG. 14 is the same as the CPU01 and the CPU02 illustrated in FIGS. 3 and 4 except that the processor does not include the transmission data selection unit TxSEL1 and the received data selection unit RxSEL2. In FIG. 14, one of 16 signal lines indicated by an X sign has a permanent fault as in FIGS. 9A and 9B.

In the case where the transmission data selection unit TxSEL1 and the received data selection unit RxSEL2 are not included, each of the data A [63:00], B [63:00], C [63:00], and D [63:00] is not distributed but just is transferred via the transfer path TP. FIG. 14 illustrates an example of transfer of the data A [63:00].

For example, when the data A [63:00] are not distributed, the data transceiver TRCV1P transmits the 64 bits of data A [63:00] to the data transceiver TRCV2P via the 16 signal lines. As a result, errors in four bits occur in the data A [63:00] in some cases. When detecting errors in two or more bits in the data A [63:00], the error correction control circuit ECC2a corresponding to the data transceiver TRCV2P has no way to correct the errors.

As described above, in the present embodiment, effects similar to those of the above-described embodiment may be obtained. For example, the transmission data selection unit TxSEL1 distributes the bit data pieces included in transmission data A, B, C, or D generated by each of the error correction control circuits ECC1, thereby making it possible to stop, for example, the transmission data A from concentrating in one signal line SG1. The received data selection unit RxSEL2 distributes the data received by the data receivers RSV2, thereby making it possible to restore the transmission data A, B, C, and D transmitted from the CPU01 at the transmission source.

As a result, it is possible to stop errors in multiple bit data pieces from occurring in any one of the transmission data A, B, C, and D, which is the unit of error correction code generation, due to a permanent fault in one signal line in the transfer path TP. In this way, the error correction control circuits ECC2 are able to detect bit errors sequentially occurring in one signal line as 1-bit errors in the restored transmission data A, B, C, and D, and correct the errors.

Accordingly, a CPU including the data selection blocks SBLK1 and SBLK2 is capable of recovering data from bit errors from which a CPU not including the data selection blocks SBLK1 and SBLK2 is uncapable of recovering data, thereby making it possible to improve the yield. As compared to a CPU not including the data selection blocks SBLK1 and SBLK2, a system equipped with a CUP including the data selection blocks SBLK1 and SBLK2 may reduce the occurrence frequency of uncorrectable errors and improve the operation rate. As a result, it is possible to improve the reliability of the CPU and a system SYS equipped with the CPU. It is also possible to reduce the manufacturing cost of the CPU and reduce the operation cost of the system SYS equipped with the CPU.

Features and advantages of the embodiments are clarified from the foregoing detailed description. The scope of claims is intended to cover the features and advantages of the embodiments as described above without departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a plurality of data transmitters which transmit data to a plurality of first signal lines, respectively;
a plurality of transmission data generators which respectively generate a plurality of first transmission data by respectively adding error correction codes to a plurality of data; and
a first data distributor that distributes and transfers a plurality of sub-data pieces included in each of the plurality of first transmission data to the plurality of data transmitters.

2. The processor according to claim 1, wherein
each of the plurality of data transmitters transmits, dividedly at a plurality of timings, the plurality of sub-data pieces distributed and transferred from the first data distributor, and
the plurality of sub-data pieces in each of the plurality of first transmission data are transmitted from the plurality of data transmitters, respectively, at timings different from each other.

3. The processor according to claim 1, wherein
a total number of the plurality of first signal lines via which the plurality of sub-data pieces are transmitted is equal to the number of bits in each of the plurality of first transmission data, and
the plurality of sub-data pieces in each of the plurality of first transmission data are distributed by the first data distributor and are output from the signal lines different from each other.

4. The processor according to claim 1, comprising:
a first distribution specification holder which rewritably holds distribution information that describes specifications about how the first data distributor is to distribute the plurality of sub-data pieces, wherein
the first data distributor distributes the plurality of sub-data pieces based on the distribution information held by the first distribution specification holder.

5. The processor according to claim 1, wherein
the first data distributor includes a plurality of first data selectors respectively corresponding to the plurality of data transmitters, and
each of the plurality of first data selectors selects a sub-data piece included in any of the plurality of first transmission data output from the plurality of transmission data generators, and transfers the selected sub-data piece to the corresponding data transmitter.

6. The processor according to claim 1, comprising:
a plurality of data receivers which respectively receive, from a plurality of second signal lines, a plurality of data generated by distributing a plurality of sub-data pieces included in each of a plurality of second transmission data to each of which an error correction code is added by a processor at a transmission source;
a second data distributor which distributes the plurality of data received by the plurality of data receivers and thereby restores the plurality of second transmission data generated by the processor at the transmission source; and
a plurality of error correctors each of which corrects an error in a corresponding one of the plurality of second transmission data restored by the second data distributor.

7. The processor according to claim 6, comprising:
a second distribution specification holder which rewritably holds distribution information that describes specifications about how the second data distributor is to distribute the plurality of received data, wherein
the second data distributor distributes the plurality of data received by the plurality of data receivers based on the distribution information held by the second distribution specification holder.

8. The processor according to claim 6, wherein
the second data distributor includes a plurality of second data selectors respectively corresponding to the plurality of error correctors, and
each of the plurality of second data selectors selects a sub-data piece included in any of the plurality of data received by the plurality of data receivers, and transfers the selected sub-data piece to the corresponding error corrector.

9. A system including a plurality of processors, each comprising data transmission blocks coupled to a plurality of first signal lines and data reception blocks coupled to a plurality of second signal lines, wherein
each of the data transmission blocks comprising:
a plurality of data transmitters which transmit data to the plurality of first signal lines, respectively;
a plurality of transmission data generators which respectively generate a plurality of first transmission data by respectively adding error correction codes to a plurality of data; and
a first data distributor that distributes and transfers a plurality of sub-data pieces included in each of the plurality of first transmission data to the plurality of data transmitters, and
each of the data reception blocks comprising:
a plurality of data receivers which respectively receive, from the plurality of second signal lines, a plurality of data generated by distributing a plurality of sub-data pieces included in each of a plurality of second transmission data to each of which an error correction code is added by a processor at a transmission source;
a second data distributor which distributes the plurality of data received by the plurality of data receivers and thereby restores the plurality of second transmission data generated by the processor at the transmission source; and
a plurality of error correctors each of which corrects an error in a corresponding one of the plurality of second transmission data restored by the second data distributor.
